(19) United States
(12) Patent Application Publication
(10) Pub. No.: US 2019/0311269 A1
(43) Pub. Date: Oct. 10, 2019

(54) NON-LINEAR PROGRAMMING PROBLEM PROCESSING DEVICE AND NON-LINEAR PROGRAMMING PROBLEM PROCESSING METHOD

(71) Applicant: NEC Corporation, Tokyo (JP)

(72) Inventor: Yoshio KAMEDA, Tokyo (JP)

(21) Appl. No.: 15/316,390

(22) PCT Filed: Jun. 1, 2015
(86) PCT No.: PCT/JP2015/002751

§ 371 Date: Jun. 12, 2019

(30) Foreign Application Priority Data
Jun. 5, 2014 (JP) 2014-116626

(51) Int. Cl. G06N 3/12

(52) U.S. Cl. CPC G06N 3/126

(57) ABSTRACT

To efficiently process a programming problem including a function defined piecewise without having the differentiability and continuity of the function expressing the problem or spatial continuity as prerequisites, a non-linear programming problem processing device is provided with: a non-linear programming problem input unit; a provisional solution generation unit that produces a solution obtained in a certain region of the non-linear programming problem as a provisional solution; a solution candidate generation unit that produces a solution obtained in a nearby region of the provisional solution as a solution candidate; a provisional solution update unit that updates the solution candidate in accordance with the result of comparison of the provisional solution and the solution candidate; an end determination unit that determines the end of the process using a provisional solution improvement degree and/or the number of times of generation of the solution candidate; and a non-linear programming problem solution output unit.

### TECHNICAL FIELD

The present invention relates to a non-linear programming problem processing device and a non-linear programming problem processing method.

### BACKGROUND ART

A mathematical programming problem is a problem in which a condition for obtaining the optimum solution of a mathematical programming problem is sought under a given restriction, and its examples include a production programming problem, a resource allocation programming problem, a transportation problem, and an energy minimization problem. Representative problems among these mathematical programming problems include a linear programming problem and a non-linear programming problem.

The linear programming problem is a problem in which a condition for minimizing or maximizing a linear objective function is sought under a restriction expressed by some linear inequalities and linear equalities. Solution methods for this problem include a well-known simplex method. Other than the simplex method, an interior method is also sometimes used.

The non-linear programming problem is a programming problem in which at least one expression of an objective function and equalities and inequalities of a restriction is non-linear. Particularly, a programming problem in which a restriction is expressed by linear inequalities and linear equalities, and an objective function is a quadratic expression is called quadratic programming problem. As a solution method for such a non-linear programming problem, some proposals have been made. For example, PTL 1 discloses a method of modifying a non-linear programming problem to be transformed into a linear programming problem. PTL 2 discloses a method for reducing the number of non-linear elements so as to simplify a solution method.

NPL 1 also describes various solution methods for a non-linear programming problem, such as a steepest descent method, a conjugate gradient method, a Newton method, a quasi-Newton method, and a successive quadratic programming method. These solution methods target a non-linear programming problem expressed by a continuous and differentiable function.

Meanwhile, for a non-linear programming method expressed by a continuous and non-differentiable function, a downhill simplex method is known. As a document disclosing such a method, PTL 3 discloses a system using a successive quadratic programming method.

PTL 2 also describes differential evolution that is one of evolutionary computation methods. The differential evolution can be applied to a spatially continuous non-linear programming problem expressed by a discontinuous function, and is a method of repeating generation change of a solution candidate group constituted by plural individuals to solve a programming problem.

Further, PTL 4 discloses, as one of solution methods for a non-linear programming problem, a device that performs division into small regions to estimate a position of a local solution, and solves a programming problem with the estimated position being a start point.

### CITATION LIST

### Patent Literature

[PTL 1] Japanese Patent Application Laid-open Publication No. 2013-254329
[PTL 2] Japanese Patent Application Laid-open Publication No.

2007-133483
[PTL 3] Japanese Patent No. 5242355
[PTL 4] Japanese Patent Application Laid-open Publication No. 1990(H2)-176904

### Non-Patent Literature

[NPL 1] Hiroshi Konno, Hiroshi Yamashita, Non-linear Programming Method, JUSE Press, Ltd., 1978
[NPL 2] Storn, R.; Price, K. (1997). “Differential evolution—a simple and efficient heuristic for global optimization over continuous spaces”. Journal of Global Optimization 11: 341-359.

### SUMMARY OF INVENTION

### Technical Problem

However, in the method of PTL 1 or PTL 2, since approximation is made by simplification of a non-linear problem into a linear problem, there is a problem that an approximation error is generated.

Further, in the method of PTL 3 or NPL 1, there is a problem that differentiability and continuity of a function expressing a programming problem is required as a precondition.

In addition, in the method of NPL 2, although differentiability and continuity of a function expressing a programming problem is not required as a precondition, there is a problem that spatial continuity is required.

Further, in the method of NPL 2, since generation change is repeated for plural individuals, there is a problem that a long time is required for calculation since the number of times of calculation becomes large.

Furthermore, in the method of PTL 4, since all of divided regions are searched, there is a problem that a long time is required for calculation since the number of times of search is increased.

Accordingly, a main object of the present invention is made in consideration of the above-mentioned problem, and to provide a non-linear programming problem processing device and a non-linear programming problem processing method that efficiently process a programming problem including a piecewise defined function, in which the differentiability and continuity of a function expressing the problem and spatial continuity is not a precondition.

### Solution to Problem

In order to solve the above-described problem, the invention of a non-linear programming problem processing device wherein a restriction or an objective function includes a piecewise defined function includes: a non-linear programming problem input unit acquiring a non-liner programming problem; a provisional solution generation unit determining as a provisional solution of the non-liner programming problem a solution obtained in a certain region of the non-liner programming problem; a solution candidate generation unit determining as a solution candidate of the non-liner programming problem a solution obtained in a region near the provisional solution; a provisional solution update unit updating the solution candidate as a provisional solution in accordance with a result of comparison between the provisional solution and the solution candidate; an end determination unit determining a process end on the basis of a determination standard that is at least one of an improvement degree of a provisional solution and the number of times of generation of a solution candidate; and a non-linear programming problem solution output unit outputting the provisional solution.

Further, the invention of a non-linear programming problem processing method wherein a restriction or an objective function includes a piecewise defined function performs: a non-linear programming problem input process of acquiring a non-linear programming problem; a provisional solution generation process of obtaining a solution in a certain region of the non-liner programming problem, and determining the solution as a provisional solution of the non-liner programming problem; a solution candidate generation process of obtaining a solution in a region near the provisional solution, and determining the solution as a solution candidate of the non-liner programming problem; a provisional solution update process of comparing the provisional solution and the solution candidate, and updating the provisional solution; a process end determination process of determining a process end on the basis of a determination standard that is at least one of an improvement degree of a provisional solution and the number of times of generation of a solution candidate; and a non-linear programming problem solution output process of outputting the provisional solution.

### Advantageous Effects of Invention

On the basis of the present invention, it is possible to attain an advantageous effect that a non-linear programming problem including a piecewise defined function can be efficiently processed, in which the differentiability and continuity of a function expressing the programming problem and spatial continuity is not a precondition.

### BRIEF DESCRIPTION OF DRAWINGS

FIG. 1 is a block diagram of a non-linear programming problem processing device according to a first example embodiment of the present invention.

FIG. 2 illustrates sections into which a definition space is divided by variables.

FIG. 3 is a flowchart expressing a processing procedure of the non-linear programming problem processing device.

FIG. 4 is a block diagram exemplifying a detailed configuration of a provisional solution generation unit.

FIG. 5 is a block diagram exemplifying a detailed configuration of a solution candidate generation unit.

FIG. 6 exemplifies operation of the solution candidate generation unit in the case 1.

FIG. 7 exemplifies operation of the solution candidate generation unit in the case 2.

FIG. 8 exemplifies operation of the solution candidate generation unit in the case 3.

FIG. 9 exemplifies operation of the solution candidate generation unit in the case 4.

FIG. 10 exemplifies operation of the solution candidate generation unit in the case 5.

FIG. 11 exemplifies operation of the solution candidate generation unit in the case 6.

FIG. 12 is a block diagram of a processing device according to a second example embodiment of the present invention.

### DESCRIPTION OF EMBODIMENTS

### First Example Embodiment

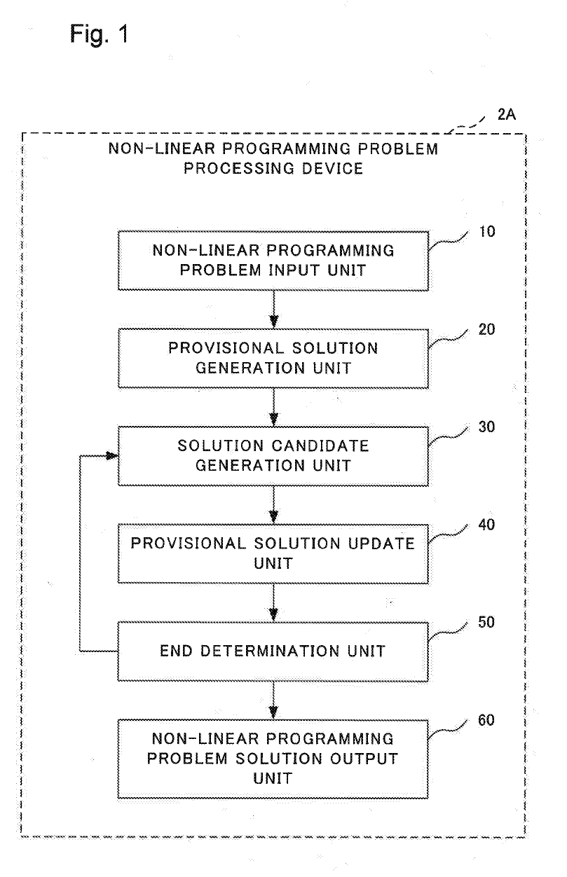

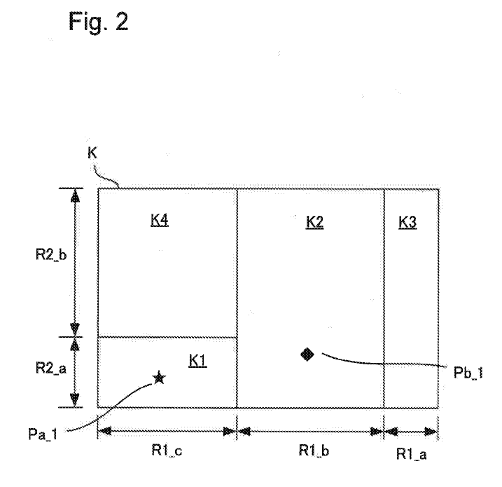

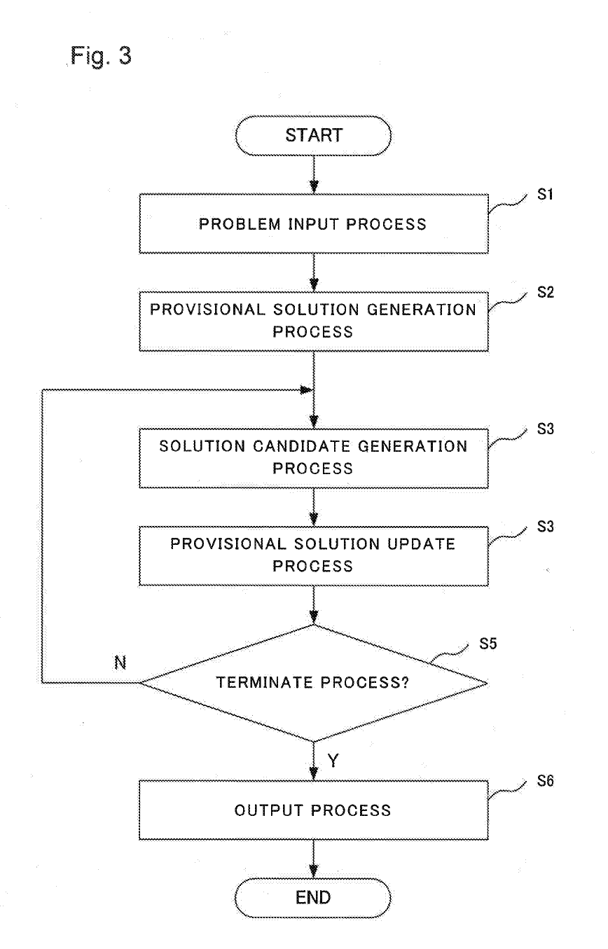

An example embodiment of the present invention is described. FIG. 1 is a block diagram of a non-linear programming problem processing device 2A according to the first example embodiment of the present invention. FIG. 2 illustrates sections into which a definition space is divided by variables. FIG. 3 is a flowchart expressing a processing procedure of the non-linear programming problem processing device 2A.

The non-linear programming problem processing device 2A includes, as main constituents, a non-linear programming problem input unit 10, a provisional solution generation unit 20, a solution candidate generation unit 30, a provisional solution update unit 40, an end determination unit 50, and a non-linear programming problem solution output unit 60.

### (Non-Linear Programming Problem Input Unit 10)

The non-linear programming problem input unit 10 performs a problem inputting process of acquiring a non-linear programming problem including a piecewise defined function (step S1). This non-linear programming problem is a problem input by a user. The non-linear programming problem is a problem including restriction expressed by an equality or an inequality and an objective function with a part of at least one of the restriction and the objective function being given for seeking a solution minimizing or maximizing the objective function with respect to a non-linear programming problem. The piecewise defined function is a set of functions in which at least one of an upper limit value and a lower limit value determining a domain of the function is defined by a section (domain) taking finite values. Particularly, the function in which each section is expressed by a linear function is called piecewise linear function, and the function in which each section is expressed by a quadratic function is called piecewise quadratic function.

Here, it is supposed that as illustrated in FIG. 2, the acquired non-linear programming problem is a problem defined by a definition space K, and each of its restriction and objective function is a piecewise linear function. In this case, it is supposed that one variable 1 is defined by sections R1_a, R1_b, and R1_c, and another variable 2 is defined by sections R2_a and R2_b. In this case, the definition space K is divided into regions K1, K2, K3, and K4 determined by combination of the sections. In one region among them, the restriction and the objective function is (a) linear function(s).

### (Provisional Solution Generation Unit 20)

The provisional solution generation unit 20 performs a provisional solution generation process of obtaining a solution of a linear programming problem in one specific region K1 (this is called provisional solution region), and determining this solution as a provisional solution Pa_1 (step S2).

### (Solution Candidate Generation Unit 30)

The solution candidate generation unit 30 performs a solution candidate generation process of obtaining a solution of a linear programming problem in another region K2 (this is called solution candidate region) different from the provisional solution region K1, in the definition region K, and determining this solution as a solution candidate Pb_1 (step S3).

### (Provisional Solution Update Unit 40)

The provisional solution update unit 40 compares values of the objective function given by the solution candidate Pb_1 and the provisional solution Pa_1. As a result of this comparison, when the value by the solution candidate Pb_1 is superior to the value by the provisional solution Pa_1, the provisional solution update unit 40 always determines the solution candidate Pb_1 as a new provisional solution, and determines the solution candidate region K2 as a new provisional solution region to update the candidate and the region. Meanwhile, when the solution candidate Pb_1 is not superior to the provisional solution Pa_1, the provisional solution update unit 40 probabilistically determines the solution candidate Pb_1 as a new provisional solution, and determines the solution candidate region K2 as a new provisional solution region to update the candidate and the region.

The superiority of the solution means that the solution candidate Pb_1 is smaller than the provisional solution Pa_1 in the case of the problem for obtaining a condition minimizing a value indicated by the objective function, and means that the solution candidate Pb_1 is larger than the provisional solution Pa_1 in the case of the problem for obtaining a condition maximizing a value indicated by the objective function.

Further, examples of a method of calculating a probability include one method of giving a probability by “e^{-|objnew-objold|*a}” when “objnew” is a value indicated by the objective function in the case of the solution candidate, “objold” is a value indicated by the objective function in the case of the provisional solution, “a” is an appropriate real number larger than 0. In this case, a probability of updating may be changed so as to be lower as the solution candidate Pb_1 is much inferior to the provisional solution Pa_1, and/or so as to be lower as the number of times of generation of a solution candidate is larger.

Probabilistically updating the solution in this manner can prevent a local optimum solution from being obtained, even when the solution candidate Pb_1 is not superior to the provisional solution Pa_1. In other words, always failing to update the provisional solution even when the solution candidate is not superior results in a higher probability that a local optimum solution is selected. Accordingly, when the solution is not superior, instead of always failing to make the update and discarding the provisional solution, the update is probabilistically made to prevent the local optimum solution from being selected.

### (End Determination Unit 50)

The end determination unit 50 determines whether the processes as described above are stopped (step S5). At this time, the end determination unit 50 uses as a determination standard at least one of an improvement degree of the provisional solution (a difference between a value of the objective function by the directly-before provisional solution and a newly adopted value of the objective function) and the number of times of generation of the solution candidate. When an absolute value of the improvement degree becomes equal to or smaller than the determination standard, or when the number of times of generation of a solution candidate becomes equal to or larger than the determination standard, the end determination unit 50 determines to end the processes.

As a result, when it is determined that the condition is not satisfied, the processing returns to the step S3, and when the condition is satisfied, the processing proceeds to the step S6.

The non-linear programming problem solution output unit 60 outputs the obtained provisional solution.

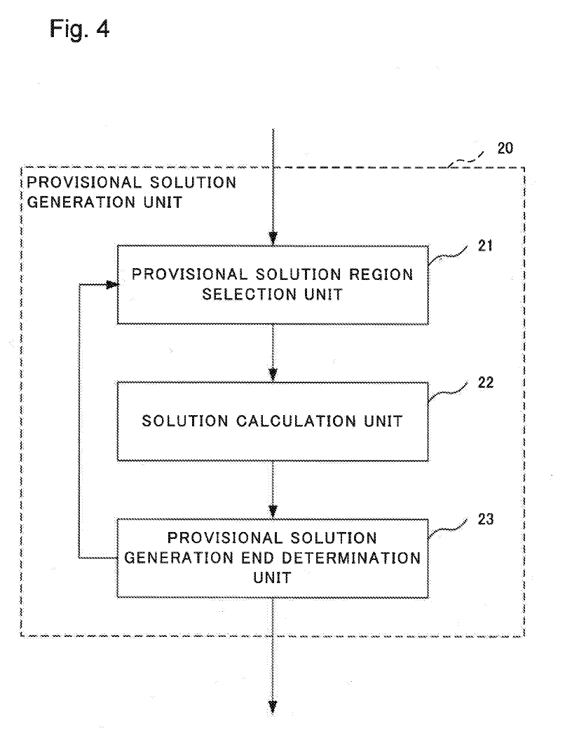

Next, a detailed configuration of the provisional solution generation unit 20 is described. FIG. 4 is a block diagram exemplifying the detailed configuration of the provisional solution generation unit 20. The provisional solution generation unit 20 includes a provisional solution region selection unit 21, a solution calculation unit 22, and a provisional solution generation end determination unit 23.

The provisional solution region selection unit 21 selects one region in the definition space K. Examples of a method of the selection include random selection, selection of a region (largest region) having the largest size in the definition space, and selection of a region at a center position (a set of centers of domains of some variables) in the definition space. In the case of the two-dimensional definition space, the largest region is a region having the largest area, and in the case of the three-dimensional definition space, the largest region is a region having the largest volume. For example, when domains (associated with the piecewise linear function) of variables of the region are [X_i_min, X_i_maX] and X_i_range=X_i_maX−X_i_min, a size of the region is given as X_1_range×X_2_range× . . . × X_N_range. Here, “N” is the number of the variables.

The solution calculation unit 22 solves a linear programming problem in the region selected by the provisional solution region selection unit 21. At this time, the solution calculation unit 22 can use a solution method for a linear programming problem such as a simplex method. Particularly, when an integer solution is required, since the linear programming problem can be treated as an integer linear programming problem, the solution calculation unit 22 can use a solution method for an integer linear programming problem such as an already-known branch-and-bound method. The solution method is determined in advance on the basis of nature (whether there is limitation to integers) of the problem, or the like. Accordingly, the solution adapted to the nature of the problem is stored in advance in the solution calculation unit 22.

When the provisional solution generation end determination unit 23 determines that the solution calculation unit 22 cannot obtain a solution, the provisional solution region selection unit 21 selects a different region again. As for the case where a solution cannot be obtained, a case, for example, where the restriction is “X+5=0 and X>0”, and the objective function (maximization) is “F(X)=X” can be exemplified. Meanwhile, when a solution is obtained by the solution calculation unit 22, the provisional solution generation unit 20 ends the process.

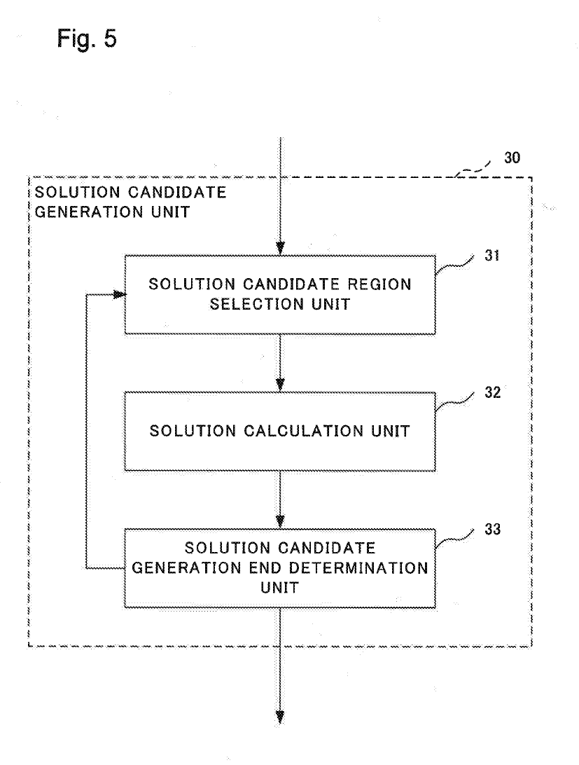

Next, a detailed configuration of the solution candidate generation unit 30 is described. FIG. 5 is a block diagram exemplifying the detailed configuration of the solution candidate generation unit 30. The solution candidate generation unit 30 includes a solution candidate region selection unit 31, a solution calculation unit 32, and a solution candidate generation end determination unit 33.

The solution candidate region selection unit 31 selects one specific region different from the provisional solution region K1, in the definition space K. A concrete example of the selection is described below.

The solution calculation unit 32 solves the linear problem, in accordance with the same solution method as the solution method in the solution calculation unit 22, in the region selected by the solution candidate region selection unit 31.

When the solution candidate generation end determination unit 33 determines that the solution calculation unit 32 cannot obtain a solution, the solution candidate region selection unit 31 selects a different region again. Meanwhile, when a solution is obtained by the solution calculation unit 32, the solution candidate generation unit 30 ends the process.

Next, description is made about an example at the time that the solution candidate generation unit 30 selects a next section, and obtains a solution candidate.

### (Case 1): One Arbitrary Region is Selected as a Solution Candidate Region Among Regions Near the Provisional Solution Region.

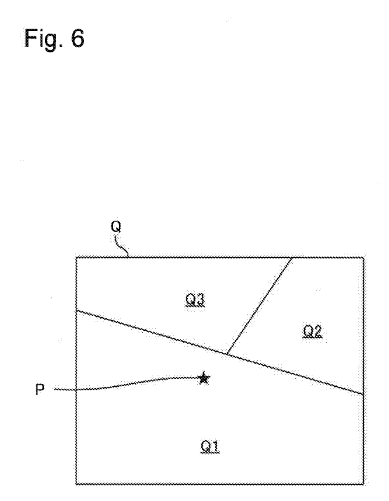

FIG. 6 exemplifies operation of the solution candidate generation unit 30 in the case 1. In this case, the solution candidate region selection unit 31 included in the solution candidate generation unit 30 selects as a solution candidate region, one arbitrary region (e.g., the region Q2), among regions near the provisional solution region Q1 in the definition space Q. Then, the solution calculation unit 32 included in the solution candidate generation unit 30 obtains a solution of the linear problem in the solution candidate region Q2.

(Case 2): A Region Including an Arbitrary Point Separated from the Provisional Solution by a Predetermined Distance is Selected as a Solution Candidate Region.

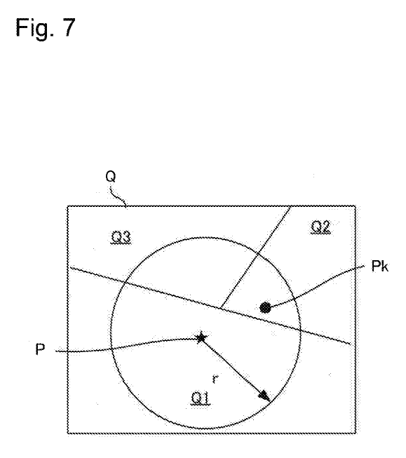

FIG. 7 exemplifies operation of the solution candidate generation unit 30 in the case 2. In this case, the solution candidate region selection unit 31 included in the solution candidate generation unit 30 selects as a solution candidate region the region Q2 including one arbitrary point Pk separated from the provisional solution P by the predetermined distance r, except for the provisional solution region Q1, in the definition region Q. Note that the solution candidate region selection unit 31 can set the distance r as an initial parameter.

At this time, the solution candidate region selection unit 31 may decrease the distance r as the number of times of the repeat increases. This is because it can be considered that an increase in the number of times of the repeat causes a provisional solution to approach the optimum solution. In such a case, when the distance is not changed, or when the distance is increased, the provisional solution sometimes shifts away from the optimum solution. In view of it, as the number of times of the repeat increases, the solution candidate region selection unit 31 decreases the distance r to search the vicinity of the provisional solution, thereby making it possible to efficiently search for the optimum solution.

Then, the solution calculation unit 32 included in the solution candidate generation unit 30 obtains a solution of the programming problem in the solution candidate region Q2.

(Case 3): A Region Positioned in a Direction Extended to a Next Provisional Solution from the Provisional Solution Directly Before Update is Selected as a Solution Candidate Region.

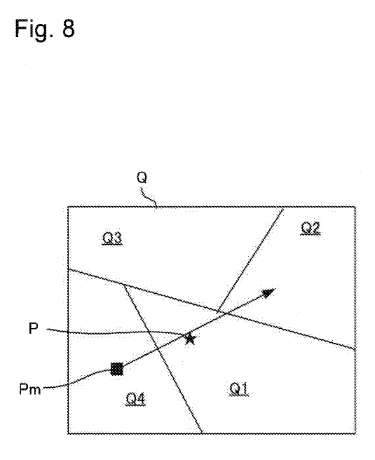

FIG. 8 exemplifies operation of the solution candidate generation unit 30 in the case 3. In this case, the solution candidate region selection unit 31 included in the solution candidate generation unit 30 selects as a solution candidate region the region Q2 that is positioned in a direction extended to the provisional solution P from the provisional solution Pm directly before update and that is closest to the provisional solution P. Then, the solution calculation unit 32 included in the solution candidate generation unit 30 obtains a solution of the linear problem in the solution candidate region Q2.

(Case 4): A Region Positioned in a Direction Extended to a Provisional Solution from a Center of Gravity of the Provisional Solution Region Directly Before Update is Selected as a Solution Candidate Region.

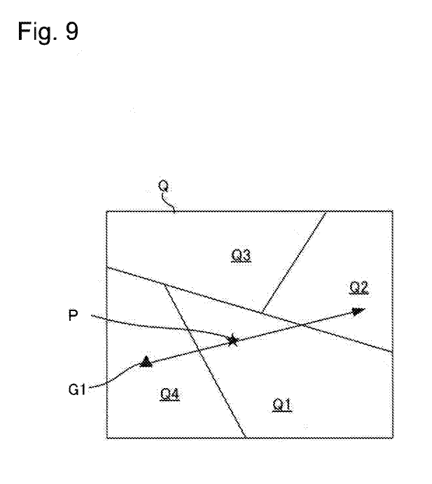

FIG. 9 exemplifies operation of the solution candidate generation unit 30 in the case 4. In this case, the solution candidate region selection unit 31 included in the solution candidate generation unit 30 selects as a solution candidate region the region Q2 that is positioned in a direction extended to the provisional solution P from the center G1 of gravity of the provisional solution region Q4 directly before update and that is closest to the provisional solution P. Then, the solution calculation unit 32 included in the solution candidate generation unit 30 obtains a solution of the linear problem in the solution candidate region Q2.

### (Case 5): A Region Having the Best Evaluation Value in an Unselected Region Near the Provisional Solution Region is Selected as a Solution Candidate Region.

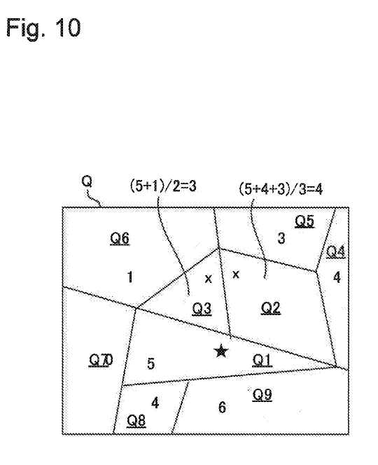

FIG. 10 exemplifies operation of the solution candidate generation unit 30 in the case 5. The solution candidate region selection unit 31 included in the solution candidate generation unit 30 obtains evaluation values of unselected regions (the region Q2 and the region Q3) near the provisional solution region Q1 in the method described below, and selects as a solution candidate region the region (region Q2) having the best evaluation value.

The method for obtaining the evaluation value is a method in which an evaluation value of a certain region is determined as an average of values indicated by the objective function in the regions that are near the certain region that have been already selected, and whose solutions have been obtained. In other words, an evaluation value is determined as a value indicated by the objective function. Here, the region having the best evaluation value is a region whose evaluation value is high in the case of an optimization problem for maximizing the objective function, and the region having the best evaluation value is a region whose evaluation value is low in the case of an optimization problem for minimizing the objective function.

For example, the evaluation value of the region Q2 is an average “(4) (=(5+4+3)/3)” of respective values (5, 4, and 3) of the objective function in the regions (the region Q1, the region Q4, and the region Q5) that are near the region Q2, that have been already selected, and whose solutions have been obtained. An initial evaluation value is determined as undefined since there are no other regions that have been already selected and whose solutions have been obtained.

Further, the evaluation value of the region Q3 is an average “3 (=(5+1)/2)” of respective values (5 and 1) of the objective function in the regions (the region Q1 and the region Q6) that are near the region Q3, that have been already selected, and whose solutions have been obtained. In the case of the non-linear programming problem for obtaining a condition in which a value of the objective function is maximized, the solution candidate region selection unit 31 selects the solution candidate region Q2 having the highest evaluation value. In this case, the solution calculation unit 32 obtains a solution of the programming problem in the selected solution candidate region Q2.

### (Case 6): A Region Having the Best Evaluation Value Among Unselected Regions Near the Provisional Solution Region is Selected as a Solution Candidate Region.

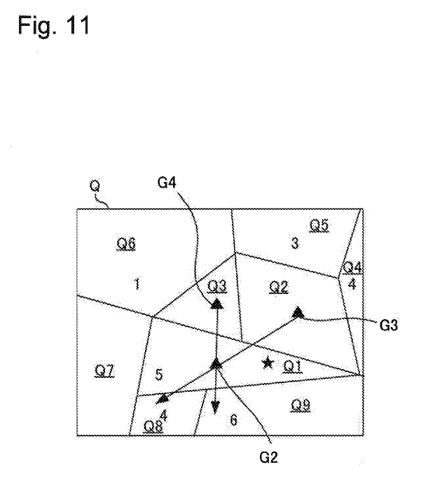

FIG. 11 exemplifies operation of the solution candidate generation unit 30 in the case 6. The solution candidate region selection unit 31 included in the solution candidate generation unit 30 obtains evaluation values of unselected regions (the region Q2 and the region Q3) near the provisional solution region Q1 in the method described below, and selects as a solution candidate region, the region (the region Q2) having the best evaluation value. When evaluation values of all unselected regions are undefined, the solution candidate region selection unit 31 selects an arbitrary region as a solution candidate region.

The region having the best evaluation value is a region having a possibility that a solution (a value indicated by the objective function is improved) better than in other regions can be obtained. In other words, the region having the best evaluation value is a region surrounded by regions in which better solutions for values indicated by the objective function exist. It is expected that in the region surrounded by such regions, a better solution for a value indicated by the objective function exists.

The method for obtaining an evaluation value is a method in which it is determined as the sum of a value indicated by the objective function in the provisional solution region Q1 and a difference between a value indicated by the objective function in the provisional solution region and a value indicated by the objective function in a region that is near the provisional solution region Q1, that is positioned in a direction extended from a center of gravity of one of unselected regions to the center G2 of the gravity of the provisional solution region Q1, and that is closest to the center G2 of gravity of the provisional solution region Q1. For example, suppose a case where three points A, B, and C are in a row, values of A and B are known, and a value of C is to be estimated. In this case, the simplest method is “(B−A)+B”. For this reason, the above-mentioned difference is “(B−A)”, and the value indicated by the objective function in the provisional solution region Q1 corresponds to B.

When a region that is near the provisional solution region Q1, that is positioned in a direction extended from a center of gravity of one of unselected regions to the center G2 of gravity of the provisional solution region Q1, and that is the closest to the center G2 of gravity of the provisional solution region Q1 is an unselected region, an evaluation value is determined as undefined.

For example, an evaluation value of the region Q2 is the sum “(6) (=1+5)” of a value (5) indicated by the objective function in the provisional solution region Q1 and a difference “(1) (=5−4)” between the value (5) indicated by the objective function in the provisional solution region Q1 and a value (4) indicated by the objective function in the region Q8 that is positioned in a direction extended from the center G3 of gravity of the region Q2 to the center G2 of gravity of the provisional solution region Q1 and that is closest to the center G2 of gravity of the provisional solution region Q1.

An evaluation value of the region Q3 is the sum “(4) (=−1+5)” of a value (5) indicated by the objective function in the provisional solution region Q1 and a difference “(−1) (=5-6)” between the value (5) indicated by the objective function in the provisional solution region Q1 and a value (6) indicated by the objective function in the region Q9 that is positioned in a direction extended from the center G4 of gravity of the region Q3 to the center G2 of gravity of the provisional solution region Q1 and that is closest to the center G2 of gravity of the provisional solution region Q1.

In the case of the non-linear programming problem for maximizing a value indicated by the objective function, the solution candidate region selection unit 31 selects the solution candidate region Q2 having the highest evaluation value, and the solution calculation unit 32 obtains a solution of the programming problem in the selected solution candidate region Q2.

As describe above, since the non-linear programming problem processing device 2A does not perform linear approximation on the non-linear programming problem, it is possible to attain an advantageous effect that an approximation error is not generated. In other words, since it is supposed that the given non-linear programming problem is expressed by plural piecewise linear functions, by making consideration section by section, it is regarded that the expression is made by only linear formulae so that linear approximation becomes unnecessary. Thus, the non-linear programming problem processing device 2A can prevent generation of an error caused by linear approximation.

Even when the non-linear programming problem is discontinuous and non-differentiable between sections, it becomes a linear programming problem continuous and differentiable in the section so that the non-linear programming problem processing device 2A can attain an advantageous effect of being able to solve the non-linear programming problem. In other words, since it is supposed that the given non-linear programming problem is expressed by plural piecewise linear functions, it becomes unnecessary for the non-linear programming problem processing device 2A to set sections, and it becomes possible to treat it as a linear programming problem continuous and differentiable in the section.

When plural individuals are generated, and the generation change is performed, if the number of the generated individuals is “N”, and the number of times of the generation change is “M”, the “N×M” number of times of calculation is necessary, and for this reason, attempting to obtain the more optimum solution (for the best value indicated by objective function) leads to large “N” and “M” and the large number of times of calculation. The non-linear programming problem processing device 2A, however, does not generate plural individuals and does not repeat the generation change, and for this reason, the number of times of calculation does not become large. Thus, the non-linear programming problem processing device 2A can shorten the calculation time.

Further, since the non-linear programming problem processing device 2A solves the programming problem only in the selected region, and does not search all the regions, the calculation time can be shortened. In other words, in the case of the number of all the regions being “N”, and the number of the selected regions being “M”, “N>M” is always satisfied, and the number of times of the calculation (time) is proportional to “N” or “M”. For this reason, the number of times of calculation (time) can be smaller (shorter) when searching is not performed on all the regions in the same manner as the non-linear programming problem processing device 2A.

### Second Example Embodiment

Next, a second example embodiment of the present invention is described. Regarding the same constituents as those of the first example embodiment, the same reference symbols are used so that the description is appropriately omitted.

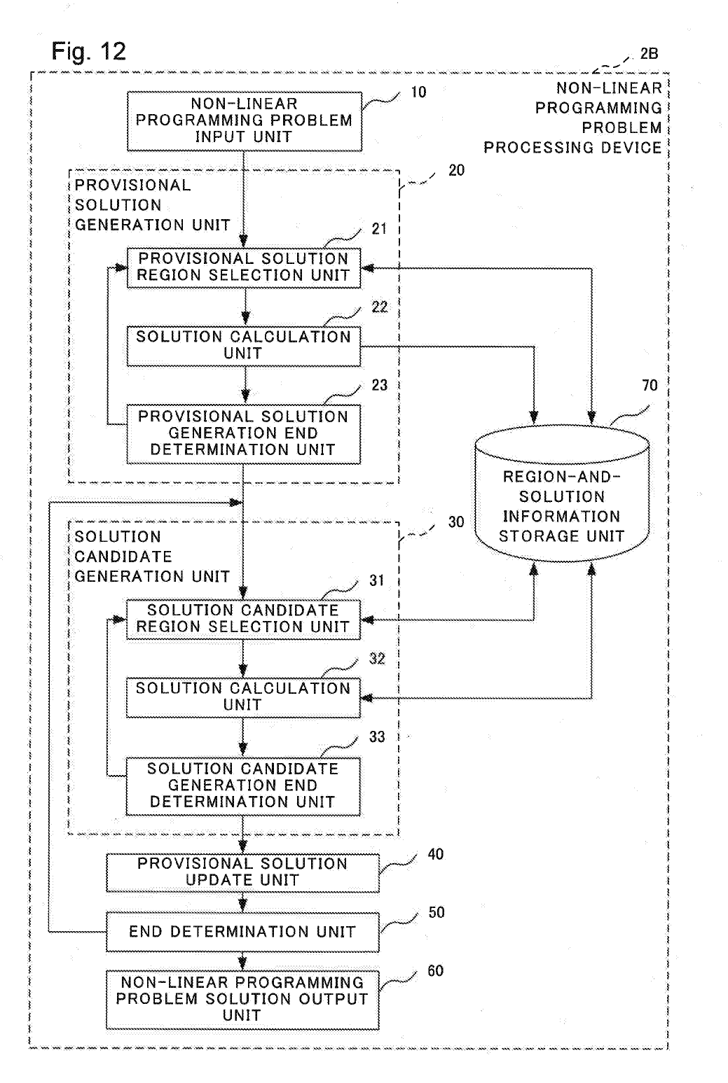

FIG. 12 is a block diagram of a non-linear programming problem processing device 2B according to the second example embodiment of the present invention. The non-linear programming problem processing device 2B differs from the above-described non-linear programming problem processing device 2A in additionally including a region-and-solution information storage unit 70. It is supposed that in an initial state, the region-and-solution information storage unit 70 is empty.

The provisional solution region selection unit 21 refers to region information stored in the region-and-solution information storage unit 70, selects as a provisional solution region a region that is not stored in the region-and-solution information storage unit 70, and adds the selected region to the region-and-solution information storage unit 70.

The solution calculation unit 22 adds a solution obtained by the solution calculation unit 22, to the region-and-solution information storage unit 70. The solution candidate region selection unit 31 refers to the region information stored in the region-and-solution information storage unit 70, and selects a solution candidate region. The solution candidate region selection unit 31 may select as the solution candidate region, a region that is not stored in the region-and-solution information storage unit 70. The solution candidate region selection unit 31 adds the selected region to the region-and-solution information storage unit 70.

The solution calculation unit 32 refers to the region-and-solution information storage unit 70 so that when a solution of the solution candidate region is stored in the region-and-solution information storage unit 70, the solution calculation unit 32 determines the stored solution as a solution to be obtained by the solution calculation unit 32.

Meanwhile, when a solution of the solution candidate region is not stored in the region-and-solution information storage unit 70, the solution calculation unit 32 obtains a solution in the region selected by the solution candidate region selection unit 31, and adds the obtained solution to the region-and-solution information storage unit 70.

For the end determination, the end determination unit 50 may refer to the region-and-solution information storage unit 70. By referring to the region-and-solution information storage unit 70, the end determination unit 50 can perform the end determination using a history of solutions. For example, if no improvement of a solution occurs over the predetermined number of times of the repeat, the end determination unit 50 may determine the end of the repeat processes. Alternatively, if a selection pattern of solution candidate regions is repeated the fixed number of times, the end determination unit 50 may determine the end of the processes.

The non-linear programming problem output unit 60 may output a solution by referring to the region-and-solution information storage unit 70. By referring to the region-and-solution information storage unit 70, the non-linear programming problem output unit 60 can output a plurality of good solutions. Accordingly, the non-linear programming problem processing device 2B can efficiently obtain a solution.

The above-described configuration enables the provisional solution region selection unit 21 and the solution candidate region selection unit 31 to select a region different from regions stored in the region-and-solution information storage unit 70, i.e., regions in which solutions have been already obtained. Accordingly, the non-linear programming problem processing device 2B can reduce the number of times of the calculation.

The solution calculation unit 32 refers to the region-and-solution information storage unit 70, and can thereby obtain a solution without solving a programming problem again, in the solution candidate region in which the programming problem have been already solved.

These enable the non-linear programming problem processing device 2B to efficiently obtain a solution.

In the first example embodiment and the second example embodiment, the solution calculation units 22 and 32 use the solution method for a linear programming problem under the supposition that each of the restriction and the objective function is a piecewise linear function. Nevertheless, when the restriction is a piecewise linear function, and the objective function is a piecewise quadratic function, the solution calculation units 22 and 32 can use a solution method for a quadratic programming problem.

The above-described respective example embodiments do not limit the present invention, and various changes that can be understood by those of ordinary skill in the art can be made within the scope of the invention of the present application.

### INDUSTRIAL APPLICABILITY

The non-linear programming problem processing device can be applied to determination of design parameters, programming of vehicle allocation or delivery, train service programming, determination of plant operation parameters, programming of operation or maintenance of an industrial process device, electric generator operation programming adjusted to electric power demand, energy supply programming, control of an environment in a building, control of an environment for agriculture, forestry, fishery, livestock farming, or the like, and control task allocation for actuation of a manipulator, a land mobile, a waterborne or underwater mobile, an aerial mobile, or the like.

While the invention has been particularly shown and described with reference to exemplary embodiments thereof, the invention is not limited to these embodiments.

It will be understood by those of ordinary skill in the art that various changes in form and details may be made therein without departing from the spirit and scope of the present invention as defined by the claims.

This application is based upon and claims the benefit of priority from Japanese patent application No. 2014-116626, filed on Jun. 5, 2014, the disclosure of which is incorporated herein in its entirety by reference.

### REFERENCE SIGNS LIST

10 Non-linear programming problem input unit
20 Provisional solution generation unit
21 Provisional solution region selection unit
22 Solution calculation unit
23 Provisional solution generation end determination unit
30 Solution candidate generation unit
31 Solution candidate region selection unit
32 Solution calculation unit
33 Solution candidate generation end determination unit
40 Provisional solution update unit
50 End determination unit
60 Non-linear programming problem solution output unit
70 Region-and-solution information storage unit

1. A non-linear programming problem processing device wherein a restriction or an objective function includes a piecewise defined function,
the device comprising:
a non-linear programming problem input unit configured to acquire a non-liner programming problem;
a provisional solution generation unit configured to determine as a provisional solution of the non-liner programming problem a solution obtained in a certain region of the non-liner programming problem;
a solution candidate generation unit configured to determine as a solution candidate of the non-liner programming problem a solution obtained in a region near the provisional solution;
a provisional solution update unit configured to update the solution candidate as a provisional solution in accordance with a result of comparison between the provisional solution and the solution candidate;
a end determination unit configured to determine a process end on the basis of a determination standard that is at least one of an improvement degree of a provisional solution and the number of times of generation of a solution candidate; and
a non-linear programming problem solution output unit configured to output the provisional solution.

2. The non-linear programming problem processing device according to claim 1, wherein the restriction is one of a linear function and a piecewise linear function, and
the objective function is one of a linear function, a piecewise linear function, a quadratic function, and a piecewise quadratic function.

3. The non-linear programming problem processing device according to claim 1, wherein the provisional solution generation unit comprises:
a provisional solution region selection unit configured to select a certain region of the non-linear programming problem;
a solution calculation unit configured to obtain a solution of a programming problem in the provisional solution region; and
a provisional solution generation end determination unit configured to determine whether the solution is good or not, repeating a provisional solution generation process when the solution is not good, and determine the solution as a provisional solution and ending a provisional solution generation process when the solution is good.

4. The non-linear programming problem processing device according to claim 1, wherein the solution candidate generation unit comprises:
a solution candidate region selection unit configured to select a region near the provisional solution;
a solution calculation unit configured to obtain a solution of a programming problem in the solution candidate region; and
a solution candidate generation end determination unit configured to determine whether the solution is good or not, repeat a solution candidate generation process when the solution is not good, and determine the solution as a solution candidate and end a solution candidate generation process when the solution is good.

5. The non-linear programming problem processing device according to claim 1, wherein the provisional solution update unit compares superiority between the provisional solution and the solution candidate, always determines the solution candidate as a new provisional solution when the solution candidate is better, and probabilistically determines the solution candidate as a new provisional solution when the solution candidate is not better.

6. The non-linear programming problem processing device according to claim 1, comprising region-and-solution information storage unit to which at least one of the provisional solution generation unit and the solution candidate generation unit can make reference and addition.

7. The non-linear programming problem processing device according to claim 1, wherein the solution candidate selection unit selects a region, using a distance from the provisional solution or a direction vector whose end point is the provisional solution.

8. The non-linear programming problem processing device according to claim 1, wherein the solution candidate selection unit selects a region, using an evaluation value of a region near a region including the provisional solution.

9. A non-linear programming problem processing method comprising:
acquiring a non-linear programming problem in which a restriction or an objective function includes a piecewise defined function;
obtaining a solution in a certain region of the non-liner programming problem, and determining the solution as a provisional solution of the non-liner programming problem;
obtaining a solution in a region near the provisional solution, and determining the solution as a solution candidate of the non-liner programming problem;
comparing the provisional solution and the solution candidate, and updating the provisional solution;
determining a process end on the basis of a determination standard that is at least one of an improvement degree of a provisional solution and the number of times of generation of a solution candidate; and
outputting the provisional solution.

10. The non-linear programming problem processing method according to claim 9, wherein the restriction is one of a linear function and a piecewise linear function, and
the objective function is one of a linear function, a piecewise linear function, a quadratic function, and a piecewise quadratic function.
